(19) United States
(12) Patent Application Publication
(10) Pub. No.: US 2011/0234102 A1
(43) Pub. Date: Sep. 29, 2011

(54) APPARATUS FOR NORMAL PRESSURE PLASMA IGNITION AND METHOD FOR NORMAL PRESSURE PLASMA IGNITION USING SAME

(76) Inventors: Ik Nyeon Kim, Seoul (KR); Young Yeon Ji, Kyonggi-do (KR)

(21) Appl. No.: 13/131,565

(22) PCT Filed: Nov. 25, 2009
(86) PCT No.: PCT/KR09/06957

§ 371 Date: May 26, 2011

(30) Foreign Application Priority Data
Nov. 26, 2008 (KR) 10-2008-0118402

(51) Int. Cl. H05H 1/46

(52) U.S. Cl. 315/111.21

(57) ABSTRACT

Provided are an apparatus for normal pressure plasma ignition and a method for normal pressure plasma ignition using the same. The apparatus for normal pressure plasma ignition of the present invention comprises a wave guide tube wherein microwaves are applied, a dielectric tube that penetrates said wave guide tube and introduces a reactant gas, and an ignition apparatus for normal pressure plasma wherein microwaves are applied in said dielectric tube to turn said reactant gas into plasma, wherein said ignition apparatus penetrates said dielectric tube and includes an ignition rod that emits thermal electrons as said microwaves are applied in said dielectric tube. The apparatus for normal pressure plasma ignition according to the present invention enables ignition to be accomplished without power, so that the problems with the prior art that requires high voltage (excessive power, stability issues) may be avoided at the same time. In addition, the normal pressure plasma ignition apparatus according to the present invention enables movement of the ignition rod inside and outside its dielectric tube so that physical damage to the ignition apparatus due to plasma heat may be prevented, and also affords the effect that the scope of metallic materials used in the ignition apparatus is significantly wider than that of the prior art.

### BACKGROUND

1. Field

This disclosure relates to an atmospheric plasma ignition apparatus and an atmospheric plasma ignition method using the same, and more particularly, to an atmospheric plasma ignition apparatus, which may make ignition in a non-electric manner, thus solving many problems caused by high voltage (e.g., excessive electric power and safety-related problem), preventing the ignition apparatus from being physically damaged due to plasma heat, and allowing to use more kinds of metal materials for the ignition apparatus than existing cases, and an atmospheric plasma ignition method using the same.

2. Description of the Related Art

If heat is continuously applied to a gaseous material to increase its temperature, an aggregate of particles, each having nucleus and electron, are made. This aggregate is called the fourth phase along with solid, liquid and gas, and the material in this phase is called plasma.

In modern industries, plasma is used in various fields for various usages, not only for materials demanding high function, high strength or high workability but also for high-tech materials for surface treatment of various materials, ion injection, deposition and removal of organic/inorganic film, cleaning work, removal of toxic substances and sterilizing or in electronic and environmental industries. In particular. in case of plasma in a vacuum state, the plasma is generated in a sealed space, so it is difficult to control instant processing conditions. In addition, in a closed system, it is hard to perform successive processes that should be carried out while an article is moving. Further, the vacuum state should be maintained, which essentially needs a vacuum technique. Moreover, such a system requires a lot of cost for installation and operation.

The atmospheric plasma technique is proposed to solve such drawbacks.

The atmospheric plasma does not need a vacuum system, and it may be directly applied to an existing production line at an atmospheric pressure without any reaction chamber, so it allows successive processing.

In case of this atmospheric plasma, plasma is generated by supplying electrons to a level required for initially generating plasma.

FIG. 1 shows an existing torch portion used for the generation of plasma, mentioned above. Here, the torch portion means a region connected to a waveguide and where plasma is generated as external electrons are injected, as well known in the art.

Referring to FIG. 1, a dielectric tube 12 is made of quartz, and its inner wall is coated with boron nitride 4 having a strong heat resistance to endure high-temperature flame. If a torch gas 8 is supplied from a gas source into the dielectric tube 12, an ignition apparatus 14 supplies initial electrons necessary for discharge, thereby causing discharge in the dielectric tube 12. At this time, due to an electromagnetic wave (microwave) with a maximum electric field, plasma is generated in the dielectric tube 12 under an atmospheric pressure. In this way, it is possible to generate plasma under an atmospheric pressure without any special vacuum device. High temperature plasma flame (5,000 to 6,000° C.) is emitted through a torch outlet of the dielectric tube 12.

The ignition apparatus 14 plays a role of generating (or, igniting) plasma by using a high voltage in an atmospheric plasma process. FIG. 2 shows an example of an existing atmospheric plasma discharging device, particularly, a microwave plasma discharging device.

Referring to FIG. 2, the existing plasma discharging device is configured such that an ignition apparatus 16 generating arc is mounted at an injection part of a torch gas 8, as shown in FIG. 1. This ignition apparatus 16 is configured in a slant direction to cross, as shown in FIG. 2, and an insulating and sealing spacer 161 is mounted thereto. Also, a power supply line 163 is connected to a lower end of the ignition apparatus 16, and conductive metal ignition tips 162 generating a high voltage arc are connected to an upper end thereof. The conductive metal ignition tip 162 is installed adjacent to a plasma generation region through an outer wall of the quartz tube 12, so a high voltage arc is generated between two conductive metal ignition tips 162. In this way, plasma is generated due to microwave in an electric field area of the microwave.

However, the existing plasma ignition apparatus causes a significant power loss since it should generate a high voltage arc. Further, it is difficult to control environments operated under a high voltage, and various safety-related problems such as electric shocks may occur. In addition, since the existing plasma ignition apparatus still remains in the dielectric tube 12 after plasma is generated, it may be easily physically damaged due to the plasma. Thus, in order to avoid such a physical damage, additional treatments are needed for the ignition apparatus, which increases process costs. Moreover, the dielectric tube should be precisely processed such that the metal tip may be inserted into the dielectric tube made of quartz, so the overall manufacture costs for the apparatus are increased.

### SUMMARY

This disclosure is to solve the above problems, and therefore this disclosure is directed to providing a new plasma ignition apparatus, which is different from an existing plasma ignition method using an applied voltage.

This disclosure is also directed to providing a plasma ignition method which is more economic and safer.

In one aspect, there is provided an atmospheric plasma ignition apparatus for making a reaction gas into plasma in a dielectric tube, the reaction gas being introduced into the dielectric tube through a waveguide and microwave being applied to the waveguide, wherein the ignition apparatus includes an ignition rod configured through the dielectric tube, the ignition rod emitting thermoelectrons when the microwave is applied thereto in the dielectric tube. The ignition apparatus includes a moving means for moving the ignition rod into or out of the dielectric tube through the dielectric tube, and the ignition rod may be made of metal, particularly tungsten. Also, the moving means may be a pneumatic actuator or an electric solenoid, and the ignition rod may be moved in association with the application of microwave, and the ignition apparatus may be moved out of the dielectric tube after a predetermined time from the application of microwave.

In another aspect, there is also provided an atmospheric plasma ignition method using microwave, wherein the ignition method includes applying microwave to an ignition rod to emit thermoelectrons, the ignition rod being capable of emitting thermoelectrons when microwave is applied thereto.

The atmospheric plasma ignition method may include: applying microwave to a waveguide; inserting the ignition rod into a dielectric tube to which a torch gas is introduced, through the waveguide to which the microwave is applied; generating plasma by the thermoelectrons emitted from the ignition rod; and moving the ignition rod out of the dielectric tube after plasma is generated, and the ignition rod may be made of metal, particularly tungsten.

Said moving the ignition rod out of the dielectric tube may include: sensing an increase of temperature caused by the generation of plasma; and moving the ignition rod out in case the temperature of the ignition rod is increased above a preset temperature, or may include: sensing the change of light caused by the generation of plasma; and moving the ignition rod out after the sensing.

The atmospheric plasma ignition apparatus disclosed herein allows ignition in a non-electric manner, so problems caused by a high voltage such as excessive power and safety-related problems may be solved. Also, in the atmospheric plasma ignition apparatus disclosed herein, since an ignition rod may be moved into or out of a dielectric tube, it is possible to prevent the ignition apparatus from being physically damaged due to plasma heat. Further, much more kinds of metal materials can be used for the ignition apparatus, in comparison to existing cases.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a schematic view showing an existing torch portion for plasma generation;

FIG. 2 shows an example of an existing atmospheric plasma discharging device, particularly a microwave plasma discharging device;

FIG. 3 is a schematic view showing an atmospheric plasma ignition apparatus disclosed herein;

FIGS. 4 to 6 are schematic views showing the ignition apparatus according to one embodiment disclosed herein for illustrating each stage of an ignition operation of an atmospheric plasma; and

FIG. 7 is a flowchart illustrating an atmospheric plasma ignition method according to one embodiment disclosed herein.

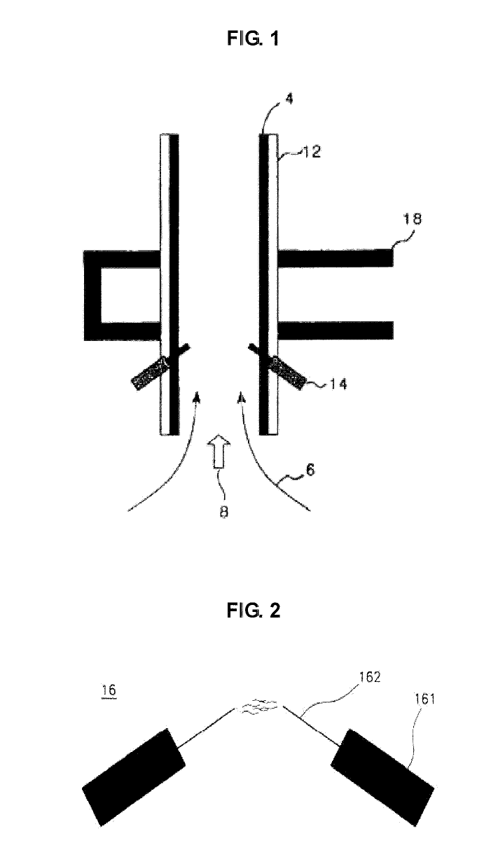

### DETAILED DESCRIPTION

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the teens first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

An ignition apparatus disclosed herein utilizes thermoelectron emission of metal, instead of an existing arc method requiring application of a high voltage. In an existing method an atmosphere plasma is generated by applying a high voltage to a metal electrode such as tungsten in a region where plasma is not generated. However, in this case, there are many problems such as economic loss caused by high voltage, safety-related problems, expensive equipments required for applying a high voltage, and so on. In addition, since the metal electrode such as tungsten is directly exposed to a plasma heat, it may be physically damaged.

The inventors found that, in case an ignition rod allowing thermoionic emission like tungsten is inserted into a dielectric tube to which a microwave is applied, thermoelectrons are emitted from the ignition rod, and, if thermoelectrons are emitted to a level required for initially igniting plasma, the generation of plasma is initiated. Further, the inventors completed this invention with the conception that the ignition apparatus may freely move through the dielectric tube since the pressures in and out of the dielectric tube where plasma is generated are identical to each other.

Hereinafter, the disclosure is described in more detail with reference to the accompanying drawings.

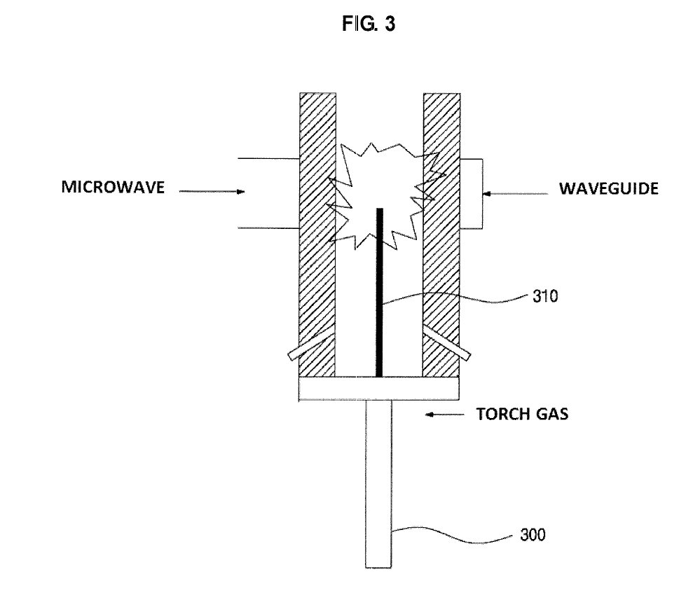

FIG. 3 is a schematic view showing an atmospheric plasma ignition apparatus disclosed herein.

Referring to FIG. 3, the atmospheric plasma ignition apparatus disclosed herein includes an ignition rod 310 for emitting electrons when heat is generated due to microwaves, and a moving means 300 connected to the ignition rod 310 to automatically move the ignition rod 310. The ignition rod may be made of any material capable of emitting thermoelectrons by means of microwaves, preferably tungsten that easily emits thermoelectrons. However, any kind of metal capable of emitting thermoelectrons may be used, not limited to tungsten.

The moving means may adopt any means capable of moving the ignition rod when an external signal or pressure is applied thereto. In other words, various kinds of moving means used in the related art such as a pneumatic actuator or an electric solenoid may be used, and any kind of moving means capable of moving the ignition rod may be selected as the above moving means.

The ignition apparatus disclosed herein does not need a special molding of a dielectric tube for insertion of a metal tip into the dielectric tube, differently from an existing case as shown in FIG. 2. Thus, the overall manufacture cost for an atmospheric plasma manufacturing system may be decreased.

Hereinafter, the operation principle of the atmospheric plasma ignition apparatus is explained with reference to the accompanying drawings.

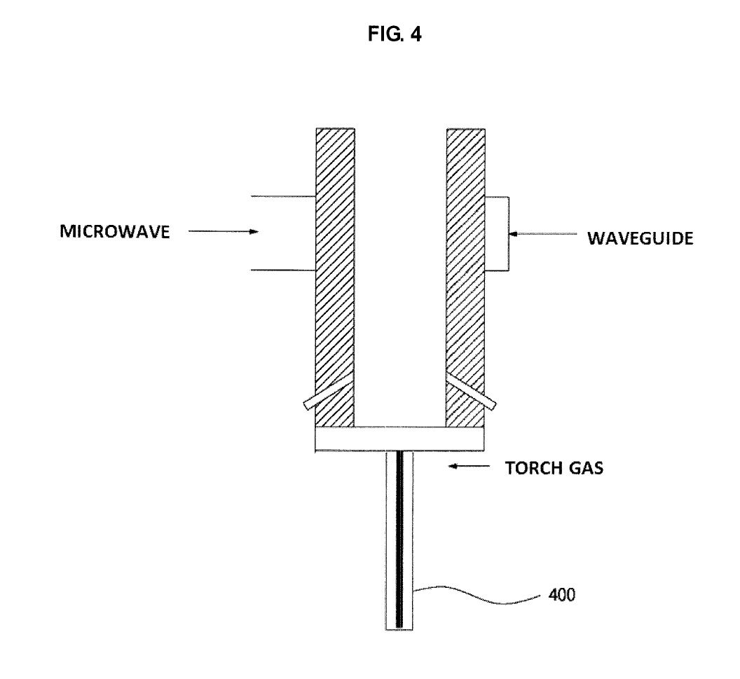

FIGS. 4 to 6 are schematic views showing the ignition apparatus according to one embodiment disclosed herein for illustrating each stage of an atmospheric plasma ignition operation.

Referring to FIG. 4, the atmospheric plasma system according to one embodiment disclosed herein includes a magnetron (not shown) for generating microwave, a waveguide through which the microwave is transmitted from the magnetron, and a dielectric tube provided with an ignition apparatus disclosed herein and to which a torch gas is introduced through the waveguide. The torch gas may be inert gas such as helium and argon, but is not limited thereto.

The ignition rod 410 may be located in or out of the dielectric tube, and FIG. 4 shows the plasma ignition apparatus having the ignition rod 410 out of the dielectric tube.

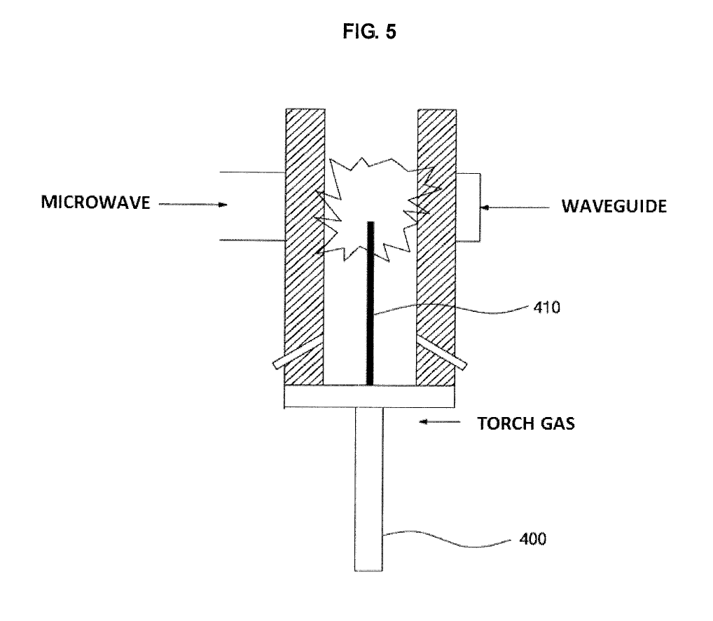

FIG. 5 is a schematic view showing that microwave is applied to the waveguide and the dielectric tube as the plasma process is initialed, and also the ignition rod 410 of the ignition apparatus is inserted into the dielectric tube.

Referring to FIG. 5, the temperature of the ignition rod 410 increases rapidly due to the applied microwave and, as a result, thermoelectrons are emitted from the ignition rod. If an amount of emitted thermoelectrons is continuously increased, the reaction gas is turned into plasma.

The shape and material of the ignition rod are not specially limited as mentioned above, but the ignition rod may have a structure capable of effectively guiding emission of thermoelectrons. For example, the ignition rod may be configured such that its end converges to one point. In this case, thermoelectrons may be sufficiently emitted from the pointed end.

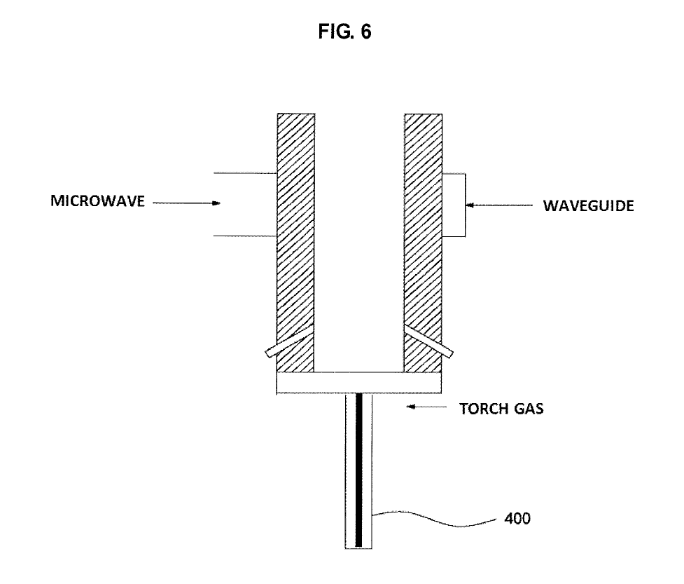

FIG. 6 is a schematic view after plasma ignition.

Referring to FIG. 6, after plasma is ignited, the ignition rod of the ignition apparatus is moved out of the dielectric tube. If the ignition rod remains in the dielectric tube, it is difficult to control plasma due to the emission of excessive thermoelectrons, and also the ignition rod may be damaged due to plasma heat. Further, a volume loss of plasma caused by the existence of the ignition rod is also expected.

Such problems are solved by moving the ignition rod using characteristics of the atmospheric plasma (Since the pressures in and out of the dielectric tube are identical to each other, the ignition rod may be moved).

In another embodiment, the ignition rod may be automatically moved.

In other words, in case a user sets a period during which sufficient thermoelectrons are emitted after microwave is applied, after the microwave turns on, the ignition rod may keep an inserted state in the dielectric tube during the preset period. Then, after a predetermined time (namely, after the plasma is ignited), the ignition rod is moved out of the dielectric tube.

The automatic movement of the ignition rod may be performed by sensing the temperature of the ignition rod or the dielectric tube. When plasma is initially generated, temperature is inevitably increased. In this case, the temperature of the dielectric tube or the ignition rod is also increased. Thus, while monitoring the increase of temperature, it is possible to move the ignition rod out of the dielectric tube in case the temperature is increased.

As an alternative, it is also possible to sense the change of light, for example UV, caused by generation of plasma. When plasma is initially generated, light is emitted to an observable level at the outside. In this case, a photo sensor, for example a UV sensor, may be used to determine whether plasma is generated, and if UV is generated to a level capable of recognizing the generation of plasma, the ignition rod ma be moved out of the dielectric tube.

The ignition apparatus described above is operated to ignite plasma by applying microwave to the ignition rod which is capable of emitting free electrons.

Hereinafter, an ignition method using the ignition apparatus explained above is described in detail with reference to the accompanying drawings.

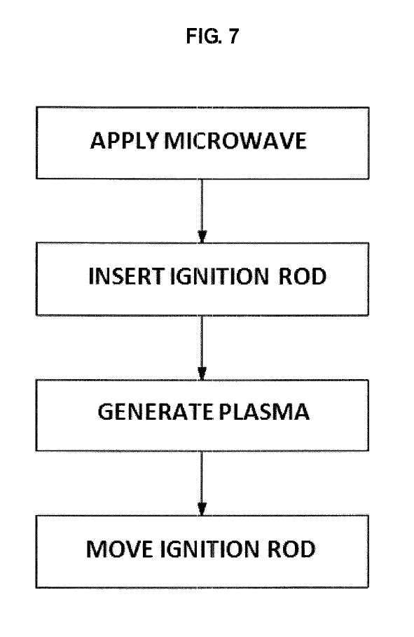

FIG. 7 is a flowchart showing an atmospheric plasma ignition method according to one embodiment disclosed herein.

Referring to FIG. 7, first, microwave is applied through the waveguide. After that, the ignition rod moves through the waveguide to which the microwave is applied, and then the ignition rod is inserted into the dielectric tube into which a torch gas is introduced. At this time, the microwave heats the ignition rod, and as a result thermoelectrons are emitted from the ignition rod.

After the thermoelectrons are emitted more than required for generating plasma, the plasma is generated in the dielectric tube. This generation of plasma is explained in more detail below through an experimental example.

Since the atmospheric plasma ignition method disclosed herein allows ignition of plasma due to the emission of electrons by microwaves without applying a high voltage, this method is very energy-efficient. Also, since plasma is generated under atmospheric conditions, the ignition rod may be moved out of the dielectric tube right after the initial ignition, so the life span of the ignition apparatus may be extended.

Detailed aspect and configuration of the atmospheric plasma ignition method disclosed herein are based on the above atmospheric plasma ignition apparatus, and will not be explained in detail again.

### EXAMPLES

The examples and experiments will now be described. The following examples and experiments are for illustrative purposes only and not intended to limit the scope of this disclosure.

Plasma Generation Experiment

While applying microwave of 2.45 GHz, 10 to 30 lpm of torch gas (helium) was flown to an atmospheric plasma system as shown in FIG. 3 for 5 to 10 seconds. After that, an ignition rod (tungsten) of the ignition apparatus was inserted into a reactor (into the dielectric tube).

Right after the ignition rod was inserted into the waveguide, the ignition rod was heated by means of microwave applied into the waveguide, and then thermoelectrons were emitted to generate arc. Also, after 1 to 5 seconds from the insertion of the ignition rod, plasma was generated.

Through this experimental example and pictures, it could be understood that atmospheric plasma may be effectively generated in the waveguide by means of a mechanical method, i.e. the insertion of the ignition rod.

While the exemplary embodiments have been shown and described, it will be understood by those skilled in the art that various changes in form and details may be made thereto without departing from the spirit and scope of this disclosure as defined by the appended claims.

In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims.

What is claimed is:

1. An atmospheric plasma ignition apparatus for making a reaction gas into plasma in a dielectric tube, the reaction gas being introduced into the dielectric tube through a waveguide and microwave being applied to the waveguide,
wherein the ignition apparatus comprises an ignition rod configured through the dielectric tube, the ignition rod emitting thermoelectrons when the microwave is applied thereto in the dielectric tube.

2. The atmospheric plasma ignition apparatus according to claim 1, wherein the ignition apparatus comprises a moving means for moving the ignition rod into or out of the dielectric tube through the dielectric tube.

3. The atmospheric plasma ignition apparatus according to claim 1, wherein the ignition rod is made of metal.

4. The atmospheric plasma ignition apparatus according to claim 3, wherein the metal comprises tungsten.

5. The atmospheric plasma ignition apparatus according to claim 2, wherein the moving means is a pneumatic actuator or an electric solenoid.

6. The atmospheric plasma ignition apparatus according to claim 2, wherein the ignition rod is moved in association with the application of microwave, and the ignition apparatus is moved out of the dielectric tube after a predetermined time from the application of microwave.

7. An atmospheric plasma ignition method using microwave, comprising applying microwave to an ignition rod to emit thermoelectrons, the ignition rod being capable of emitting thermoelectrons when microwave is applied thereto.

8. The atmospheric plasma ignition method according to claim 7, comprising:
applying microwave to a waveguide;
inserting the ignition rod into a dielectric tube to which a torch gas is introduced, through the waveguide to which the microwave is applied;
generating plasma by the thermoelectrons emitted from the ignition rod; and
moving the ignition rod out of the dielectric tube after plasma is generated.

9. The atmospheric plasma ignition method according to claim 7, wherein the ignition rod is made of metal.

10. The atmospheric plasma ignition method according to claim 9, wherein the metal comprises tungsten.

11. The atmospheric plasma ignition method according to claim 8, wherein said moving the ignition rod out of the dielectric tube comprises:
sensing an increase of temperature caused by the generation of plasma; and
moving the ignition rod out in case the temperature of the ignition rod is increased above a preset temperature.

12. The atmospheric plasma ignition method according to claim 8, wherein said moving the ignition rod out of the dielectric tube comprises:
sensing a change of light caused by the generation of plasma; and
moving the ignition rod out after said sensing.
